(19) United States
(12) Patent Application Publication
(10) Pub. No.: US 2025/0060160 A1
(43) Pub. Date: Feb. 20, 2025

(54) REAL-TIME MEASUREMENT OF DESUBLIMATION IN A FREEZE-DRYING SYSTEM

(71) Applicant: SP Industries, Inc., Warminster, PA (US)

(72) Inventor: Paul W. Coiteux, New Paltz, NY (US)

(21) Appl. No.: 18/800,875

(22) Filed: Aug. 12, 2024

Related U.S. Application Data
(60) Provisional application No. 63/532,610, filed on Aug. 14, 2023.

(51) Int. Cl. F26B 5/06; G01N 25/14

(52) U.S. Cl. CPC F26B 5/06; G01N 25/14

(57) ABSTRACT

Disclosed herein are embodiments for real-time measurement of drying in a freeze-drying system. In at least one embodiment, the freeze-drying system includes a freeze-drying chamber; a condenser coupled to the freeze-drying chamber; one or more load sensors; and a processing device operatively coupled to the one or more load sensors and configured to measure mass change of components of the freeze-drying system during a freeze-drying process.

### CROSS-REFERENCE TO RELATED APPLICATION(S)

This application claims the benefit of priority of U.S. Provisional Patent Application No. 63/532,610, filed Aug. 14, 2023, the disclosure of which is hereby incorporated by reference herein in its entirety.

### TECHNICAL FIELD

The present disclosure relates to field of freeze-drying systems, and more particularly, to computing parameters during freeze-drying processes.

### BACKGROUND

Freeze-drying (e.g., lyophilization, cryodesiccation) is a process to remove water and/or other solvents from products. Freeze-drying has many applications such as preserving a perishable material, making a material more convenient for transport, making of ceramics, producing a product that has a short reconstitution time with acceptable potency levels, and so forth. Freeze-drying can be used for many different materials, including, but not limited to, food, pharmaceuticals, and biological specimens.

In a typical freeze-drying process, the sample, or vials or containers containing the sample, are loaded on temperature-controlled shelves within a chamber and cooled to low temperatures until completely solidified. The freeze-drying chamber pressure is then reduced and the shelf temperature is adjusted to enable removal of the frozen solvent (i.e., drying) via sublimation in a step referred to as “primary drying.” When sublimation is complete, the shelf temperature is raised during a “secondary drying” step to remove additional un-frozen solvent bound to the solid product by, for example, adsorption. When sufficient solvent is removed, the drying process is concluded. If the sample was contained in vials or containers, the vials or containers are then sealed, typically under a sub-ambient pressure of inert gas.

It is important that pharmaceutical products are correctly lyophilized during every batch produced. Current processes are often validated though engineering batches, and then shelf temperature, condenser temperature, and pressure data are recorded. However, without product temperature data, excursions from the defined process may be missed and product quality could be affected by small variations.

### SUMMARY OF THE DISCLOSURE

The following presents a simplified summary of various aspects of the present disclosure in order to provide a basic understanding of such aspects. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

In one aspect of the present disclosure, a freeze-drying system comprises: a freeze-drying chamber; a condenser coupled to the freeze-drying chamber; one or more load sensors; and a processing device operatively coupled to the one or more load sensors and configured to measure mass change of components of the freeze-drying system during a freeze-drying process.

In at least one embodiment, the one or more load sensors are disposed on support structures of the freeze-drying chamber. In at least one embodiment, the one or more load sensors are disposed on support structures of the condenser.

In at least one embodiment, the freeze-drying chamber further comprises a stoppering mechanism configured to apply pressure to a shelf stack disposed within the freeze-drying chamber. In at least one embodiment, the one or more load sensors are disposed on the stoppering mechanism.

In a further aspect of the present disclosure, a freeze-drying system comprises: a freeze-drying chamber; a condenser coupled to the freeze-drying chamber via one or more conduits; a hydraulic ram configured to apply pressure to a shelf stack disposed within the freeze-drying chamber at a pressure plate; a hydraulic fluid pressure sensor configured to measure pressure on the hydraulic ram; and a processing device operatively coupled to the hydraulic fluid pressure sensor to measure mass change on the shelf stack during a freeze-drying process.

In at least one embodiment, the measured mass change corresponds to ice accumulation on the condenser during the freeze-drying process. In at least one embodiment, the processing device is further configured to compute a drying parameter of a product in the freeze-drying chamber corresponding to a given point or period in time based on mass transfer from the product to the condenser as accumulated ice during the freeze-drying process.

In at least one embodiment, the drying parameter is selected from a batch average temperature, cake resistance, and heat transfer coefficient.

In a further aspect of the present disclosure, a method of computing batch average temperature of a product during a freeze-drying process at a given point or period in time comprises: monitoring, by a processing device, mass transfer from the product to a condenser as accumulated ice during the freeze-drying process; and computing, by the processing device, a drying parameter of the product based on the monitored mass transfer.

In at least one embodiment, the drying parameter is selected from a batch average temperature, cake resistance, and heat transfer coefficient.

In at least one embodiment, monitoring the mass transfer comprises monitoring mass change via one or more load sensors disposed on support structures of a freeze-drying chamber containing the product. In at least one embodiment, monitoring the mass transfer comprises monitoring mass change via one or more load sensors disposed on support structures of the condenser. In at least one embodiment, monitoring the mass transfer comprises monitoring mass change via one or more load sensors disposed on a hydraulic ram configured to apply pressure to a shelf stack disposed within a freeze-drying chamber containing the product. In at least one embodiment, the mass transfer comprises monitoring mass change via a hydraulic fluid pressure sensor configured to measure pressure of a hydraulic ram configured to apply pressure to a shelf stack disposed within a freeze-drying chamber containing the product.

In at least one embodiment, the method further comprises causing, by the processing device, a display device to display the drying parameter during the freeze-drying process.

In a further aspect of the present disclosure a method comprises: implementing, by a processing device, a freeze-drying process for a freeze-drying system according to a process recipe, the process recipe specifying a drying parameter for a product; monitoring, by the processing device, mass transfer from the product to a condenser as accumulated; computing, by the processing device, the drying parameter at a given point or period in time based on the monitored mass transfer; and periodically adjusting, by the processing device, the process recipe to cause the computed drying parameter reach and stabilize at or near a target batch average temperature.

In at least one embodiment, the drying parameter is selected from a batch average temperature, cake resistance, and heat transfer coefficient.

In at least one embodiment, monitoring the mass transfer comprises monitoring mass change via one or more load sensors disposed on support structures of a freeze-drying chamber containing the product.

In at least one embodiment, monitoring the mass transfer comprises monitoring mass change via one or more load sensors disposed on support structures of the condenser.

In at least one embodiment, monitoring the mass transfer comprises monitoring mass change via one or more load sensors disposed on a hydraulic ram configured to apply pressure to a shelf stack disposed within a freeze-drying chamber containing the product.

In at least one embodiment, monitoring the mass transfer comprises monitoring mass change via a hydraulic fluid pressure sensor configured to measure pressure of a hydraulic ram configured to apply pressure to a shelf stack disposed within a freeze-drying chamber containing the product.

In at least one embodiment, the method further comprises: causing, by the processing device, a display device to display the drying parameter during the freeze-drying process.

In a further aspect of the present disclosure, a non-transitory machine-readable medium has instructions encoded thereon that, when executed by a processing device of a freeze-drying system, cause the processing device to implement any of the aforementioned freeze-drying processes or methods.

### BRIEF DESCRIPTION OF THE DRAWINGS

The present disclosure is illustrated by way of example, and not by way of limitation, in the figures of the accompanying drawings.

FIG. 1A is an illustration of a front view of an exemplary freeze-drying system, in accordance with at least one embodiment of the disclosure.

FIG. 1B is an illustration of a side view of the exemplary freeze-drying system, in accordance with at least one embodiment of the disclosure.

FIG. 2 is a schematic view of an exemplary freeze-drying system configured for mass flow monitoring, in accordance with at least one embodiment of the disclosure.

FIG. 3 is a flow diagram illustrating an exemplary method of computing batch average temperature of a product during a freeze-drying process, in accordance with at least one embodiment of the disclosure.

FIG. 4 is a flow diagram illustrating an exemplary method of controlling batch average temperature of a product during a freeze-drying process, in accordance with at least one embodiment of the disclosure.

FIG. 5 is an exemplary computer system for use in accordance with various embodiments of the present disclosure.

### DETAILED DESCRIPTION

Embodiments of the present disclosure relate to non-invasive approaches to computing batch average temperature for a product during freeze-drying processes at a given point or period in time, which provide data to help an operator of a freeze-drying system maintain the drying process within acceptable limits during the drying cycle.

The freeze-drying process includes at least a freezing stage, a primary drying (e.g., sublimation) stage, and a secondary drying (e.g., desorption) stage. During the freezing stage, a product is frozen and ice crystals are formed in the product. During the primary drying stage, water is removed from the product via sublimation of the free ice crystals by an increase in temperature. During the secondary drying stage, the temperature is raised to remove bound water molecules from the product.

Batch average temperature for a product can be calculated from a heat flow algorithm developed following the work laid out by Milton et al. (“Evaluation of Manometric Temperature Measurements a Method of Monitoring Product Temperature During Lyophilization,” PDA Journal of Pharmaceutical Science & Technology, Vol. 51, No. 1, January-February 1996) and Tang et al. (“Freeze Drying Process Design By manometric temperature measurement: Design of a Smart Freeze-Dryer,” Pharmaceutical Research, Vol. 22, No. 4, April 2005), according to:
Heat flow from shelf to product (cal s⁻¹):

$$\frac{dQ}{dt} = {A}_{v} {K}_{v} ( {T}_{s} - {T}_{p} )$$

Mass transfer (g s⁻¹):

$$\frac{d m}{dt} = {A}_{p} \frac{{P}_{0} - {P}_{c}}{{R}_{p}}$$

where Aᵥ is the cross-sectional area of the sample vial (cm²),
Kᵥ is the vial heat transfer coefficient (cal s⁻¹ cm⁻² K⁻¹),
Tₛ is the shelf temperature (° C.),
Tₚ is the product temperature (° C.),
Aₚ is the cross-sectional area of the product (cm²),
P₀ is the vapor pressure of ice at the sublimation interface (mTorr),
P_{c} is the chamber pressure (mTorr), and
Rₚ is the area normalized product resistance (cm² hr Torr g⁻¹).

Batch average temperature can be measured in the laboratory scale equipment via manometric temperature measurement (MTM). The data generated via MTM can be used with the heat flow algorithm to infer various critical product batch data for the product as it dries, such as ice interface temperature, dried cake resistance, and other relevant data. However, MTM cannot be used in production systems because it is invasive in nature (e.g., by causing a pressure rise in the freeze-drying chamber) and because isolation valves at large scale do not close quickly enough to enable accurate MTM calculation.

Wireless thermocouples can be used, but their presence has a significant impact on the product being measured, and as such makes the sample being monitored not representative of the rest of the vials without such a sensor. Moreover, wired thermocouples can contaminate the product, only measure a specific point, and affect how the sample vial dries, and are thus prone to producing artifacts in the results.

Measurement of water vapor through the throat of a dryer between the freeze-drying chamber and the condenser could potentially be used to estimate mass transfer (e.g., mass transfer rate). However, this approach can be costly to install and complex to operate, and requires separation of the chamber and condenser with a vapor duct of three to six feet in length, which may cause space constraints in the facility.

The embodiments described herein advantageously overcome the shortcomings of current methods by providing an alternative non-invasive approach to monitor mass flow in a freeze-drying system. This can be achieved by measuring the accumulation (e.g., rate of mass change) in the desublimator (condenser). This mass accumulation can be utilized in accordance with the algorithms described above to infer critical product batch data for the product. Exemplary embodiments for measuring or estimating mass transfer (e.g., mass transfer rate) include, but are not limited to: (1) inclusion of load cells under the condenser to monitor mass increase during drying; (2) inclusion of load cells underneath one or more of the condenser and optionally the freeze-drying chamber to monitor mass shift from the freeze-drying chamber to the condenser; (3) monitoring pressure on a hydraulic ram to detect a decrease in mass of a shelf stack within the freeze-drying chamber; (4) inclusion of a load cell on the hydraulic ram; and (5) a combination thereof. These embodiments exemplify the approach, and are described in greater detail below. It is contemplated that other suitable approaches to measuring or estimating mass flow from a product in a freeze-drying chamber could also be utilized.

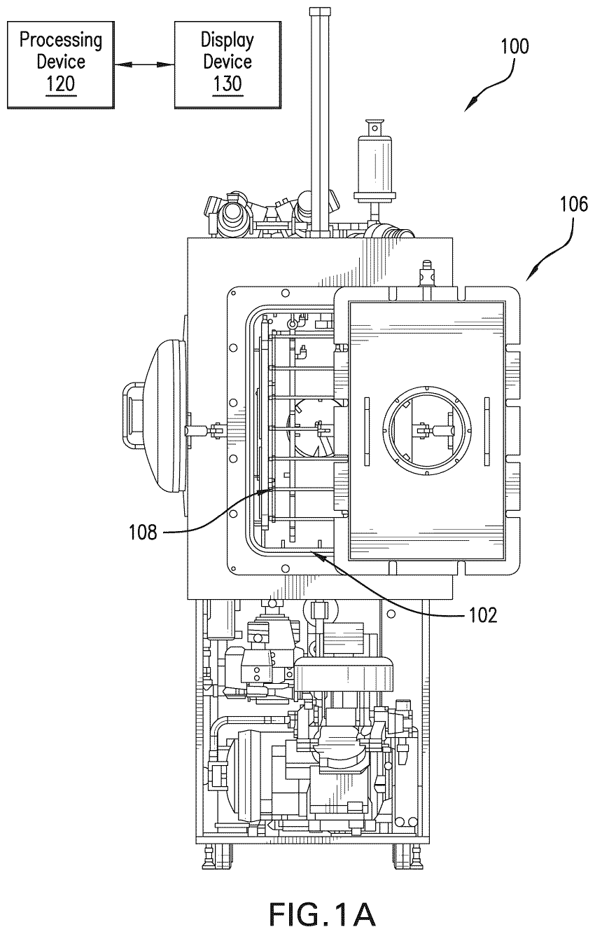

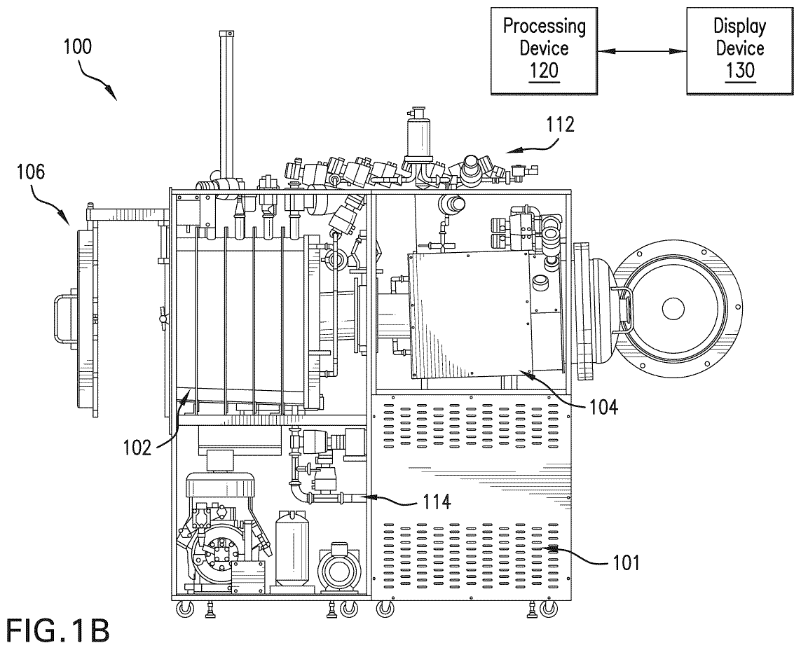

FIGS. 1A and 1B are illustrations of front and side views, respectively, of an exemplary freeze-drying system 100 in accordance with embodiments of the present disclosure. The freeze-drying system 100 may perform freeze-drying of a product. The freeze-drying process may include multiple stages (e.g., a freezing stage, a primary drying stage, a secondary stage, etc.). The freeze-drying system 100 may include a housing 101 that encloses or supports various components of the freeze-drying system 100, such as a chamber 102 for loading samples, a condenser 104, fluid lines, gas lines, etc. The chamber 102 may be accessible via a door 106 that can seal the chamber 102 and sustain vacuum conditions within the chamber 102. The chamber 102 may include one or more shelves of a shelf stack 108 disposed thereon, which may be used for securing samples. One or more inlets 112 may facilitate gas flow and/or vacuum attachments to control, respectively, gas flow into the chamber 102 and vacuum conditions within the chamber 102. A drain 114 may be used to remove excess water from the chamber, for example, resulting from ice formation.

In certain embodiments, the chamber 102 may include one or more orifices for connecting various valves and gauges. For example, a gauge, such as a Pirani gauge, may be coupled to the chamber to measure pressure within the chamber 102.

In at least one embodiment, the shelves of the shelf stack 108 may be thermally coupled to a heating element for temperature control. In at least one embodiment, the heating element may be an electric heating device. In at least one embodiment, the heating element may be one or more fluid lines that are thermally coupled the shelves of the shelf stack 108, which may regulate heat delivered to the shelves by fluid flow through the one or more fluid lines. In certain embodiments, the condenser 104 is an external condenser, which may be contained with or supported by the housing 101, or may be separate entirely from the housing 101.

In at least one embodiment, the freeze-drying system 100 includes a processing device 120 and a display device 130 that is operatively coupled to the processing device 120. Though not shown explicitly, the processing device 120 may be operatively coupled to one or more components of the freeze-drying system 100 to control the freeze-drying process, either directly or remotely via a network interface, which includes regulation of fluid flow rates through one or more refrigerant fluid lines, control of various valves, and measurement of temperatures and pressures within the components of the freeze-drying system 100. In at least one embodiment, the processing device 120 may control, or may be part of a larger control system that controls, various aspects of a freeze-drying system 100, including, but not limited to, gas flow or vacuum conditions in the chamber 102 and temperature cycles. The processing device 120 may be a programmable flow controller, in at least one embodiment, and may be programmed to execute a freeze-drying recipe.

In at least one embodiment, one or more of the processing device 120 or the display device 130 may be integrated with one or more components of the freeze-drying system 100, for example, as a control interface to allow a user to program a recipe and cause the recipe to be executed. The freeze-drying system 100 may include various control hardware (e.g., one or more processing devices) and software systems adapted to command and coordinate the various elements of the freeze-drying system 100, and carry out the pre-programmed freeze-drying cycle. The various control hardware and software systems may also provide documentation, data logging, alarms, and system security capabilities as well. In addition, auxiliary systems to the freeze-dryer system may include a leak check system, performance check system, and various subsystems to clean and sterilize the product chamber and/or auto-load/unload the product in the product chamber, as well as associated mechanical or cryogenic refrigeration system accessories such as refrigeration skids, compressors, condensers, heat exchangers, heat transfer fluid systems, pumps, heaters, expansion tanks, cryogen tanks, piping, valves, sensors, etc.

Aspects of the freeze-drying recipe, measurements, and other relevant information may be displayed by the display device 130. In at least one embodiment, the processing device 120 may control the positions of various valves to regulate the flow paths of fluid through the fluid lines, thus facilitating thermal coupling between the shelf stack 108 and the condenser 104. In at least one embodiment, the processing device 120 may determine when to thermally couple the shelves of the shelf stack 108 to the condenser 104, for example, in response to determining that a temperature of water exiting the condenser 104 has reached a particular temperature range.

After freezing of the sample is complete, drying steps are initiated. The drying steps may include a primary drying step and secondary drying step. Primary drying involves activating a vacuum pump and condenser refrigeration system to establish the desired sublimation and condensing conditions in the chamber 102. In at least one embodiment, a small bleed flow of a gas (e.g., an inert gas) into the chamber throughout the drying process to help control the vacuum level. After the vacuum pressure conditions are attained, the shelves of the shelf stack 108 are warmed (e.g., using waste heat from the condenser, as will be discussed in more detail below) to the desired primary drying temperature, which is dictated by the thermal and mechanical properties of the material undergoing freeze-drying. Primary drying is completed when all the unbound water has been removed by sublimation, as determined by one or more of product temperature measurements, humidity measurements, comparison of capacitance manometer and Pirani gauge measurements, analysis of samples obtained with a sample thief, or other techniques. Once primary drying is complete, the freeze-dryer shelf temperatures are further increased at a desired warming rate until the product or materials reach a temperature when desorption of bound water may be adequately achieved. This final product temperature depends on product composition and could be about 20° C. or higher. After drying is complete, the product or material is removed from the chamber 102. At any time during the process, the freeze-drying system 100 may be capable of emergency stop or shutdown, which would close the pressurization and depressurization control valves while the chamber remains under vacuum.

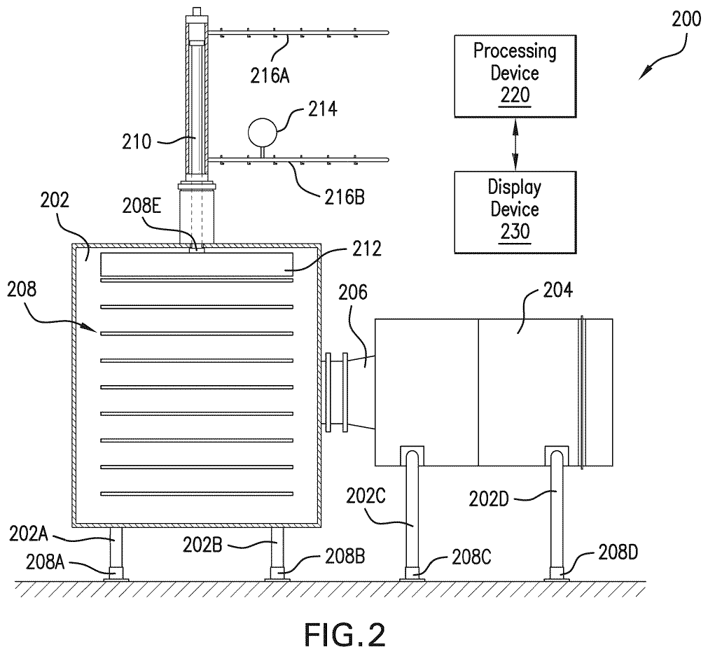

FIG. 2 is a schematic view of an exemplary freeze-drying system 200 configured for mass flow monitoring in accordance with at least one embodiment of the disclosure. Freeze-drying system 200 includes a freeze-drying chamber 202 and an external condenser 204, which is thermally coupled to an interior space of the chamber 202 via a conduit 206. Within the interior space of the chamber 202 is a shelf stack 208, which includes a series of parallel shelves for holding samples/products during a freeze-drying process. In at least one embodiment, the shelf stack 208 is removable and can be loaded into the chamber 202 from the top of the chamber 202. In at least one embodiment, a hydraulic ram 210 and a pressure plate 212 form a sealing assembly. During operation, the hydraulic ram 210 applies a force to the pressure plate 212 to drive the pressure plate 212 against the shelf stack 208 and form a seal. Hydraulic fluid may be provided by hydraulic supply/return lines 216A and 216B, and a pressure sensor 214 may be present to monitor the pressure.

Each of the chamber 202 and the condenser 204 are supported by various support structures. For example, the chamber 202 is supported by support structures 202A and 202B, and the condenser 204 is supported by support structures 202C and 202D. Though not shown, other support structures may be present. In at least one embodiment, one or more sensors 208A-208D are utilized to measure and monitor changes in mass during operation of the freeze-drying system 200. For example, the sensors 208A-208D are disposed on support structures 202A-202D, respectively. In at least one embodiment, one or more sensors 208E may be disposed on the pressure plate 212 in order to detect decreases in mass in the shelf stack 208. In at least one embodiment, the sensors 208A-208E include one or more load cells, thin film pressure sensors, strain gauges, or other suitable sensors for mass measurement. The freeze-drying system 200 may further include a processing device 220 and a display device 230, which may perform similar functionality as their identically named counterparts of FIG. 1. In at least one embodiment, the processing device 220 may be communicatively coupled to one or more of the sensors 208A-208E to monitor change in mass.

Other arrangements of the components of the freeze-drying system 200 are contemplated, and thus the embodiments described herein are not limited to those disclosed, as would be appreciated by one of ordinary skill in the art.

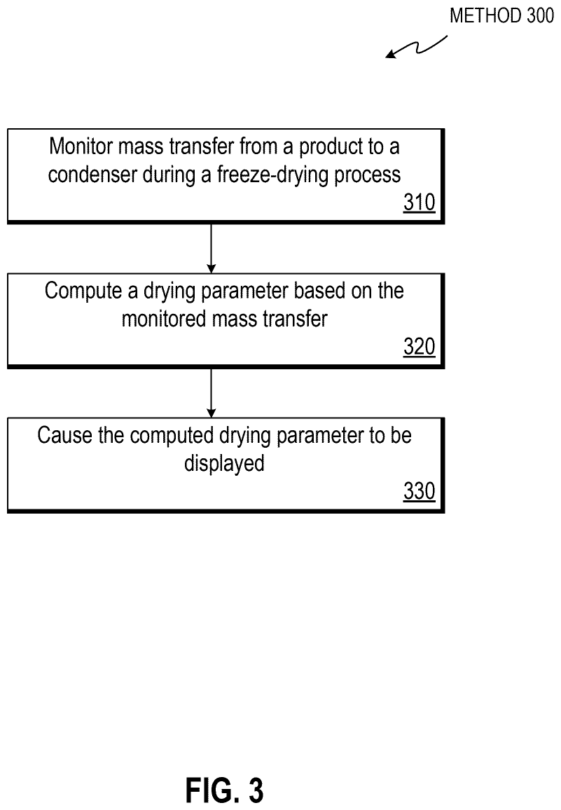

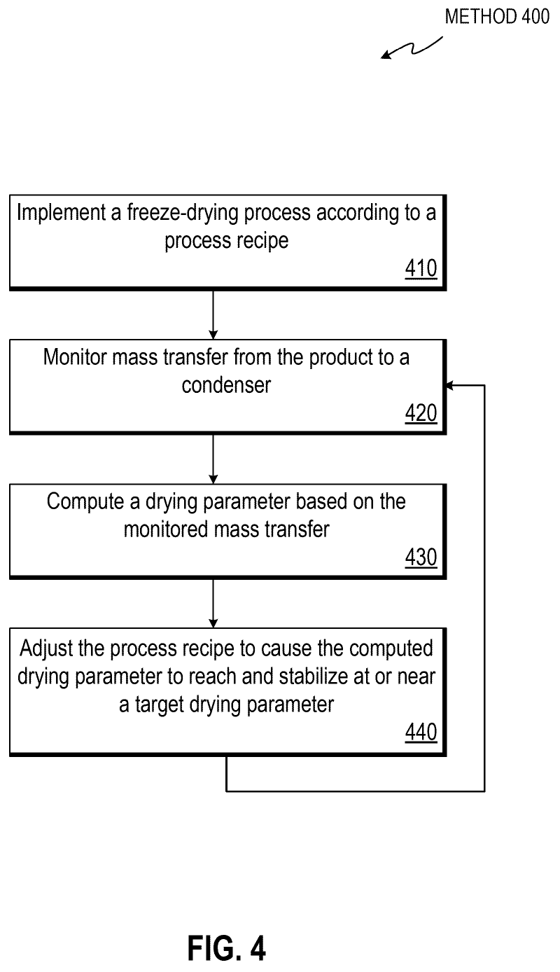

FIG. 3 is a flow diagram illustrating an exemplary method 300 of computing a drying parameter of a product, such as batch average temperature, during a freeze-drying process at a given point or period in time, in accordance with at least one embodiment of the disclosure. FIG. 4 is a flow diagram illustrating an exemplary method 400 of controlling a drying parameter of a product, such as batch average temperature, during a freeze-drying process in accordance with at least one embodiment of the disclosure. Both of the methods 300 and 400 may be performed with the freeze-drying system 200 or variants thereof, and performed by a processing device (e.g., by the processing device 220) implementing processing logic. The processing logic may comprise hardware (e.g., circuitry, dedicated logic, programmable logic, microcode, etc.), software (e.g., instructions run on a processing device to perform hardware simulation), or a combination thereof.

Referring now to FIG. 3, the method 300 begins at block 310, where the processing device monitors mass transfer (e.g., mass transfer rate) from a product in a freeze-drying chamber (e.g., the chamber 202) to a condenser (e.g., the condenser 204). For example, the mass transfer corresponds to a flow of water vapor from the product in the chamber to the condenser as accumulated ice (desublimation).

In at least one embodiment, monitoring the mass transfer comprises monitoring mass change via one or more load sensors (e.g., the sensors 208A and 208B) disposed on support structures of a freeze-drying chamber containing the product.

In at least one embodiment, monitoring the mass transfer comprises monitoring mass change via one or more load sensors (e.g., the sensors 208C and 208D) disposed on support structures of the condenser.

In at least one embodiment, monitoring the mass transfer comprises monitoring mass change via one or more load sensors (e.g., the sensor 208E) disposed on a stoppering mechanism (e.g., the hydraulic ram 210) configured to apply pressure to a shelf stack (e.g., the shelf stack 208) disposed within a freeze-drying chamber containing the product.

In at least one embodiment, monitoring the mass transfer comprises monitoring mass change via a hydraulic fluid pressure sensor (e.g., the pressure sensor 214 operatively coupled to the processing device 220) configured to measure pressure of a hydraulic ram configured to apply pressure to a shelf stack disposed within a freeze-drying chamber containing the product.

At block 320, the processing device computes the drying parameter at a given point or period in time, based on the monitored mass transfer (e.g., rate of mass flow using the heat flow algorithm described above). In at least one embodiment, the drying parameter is selected from batch average temperature, cake resistance, and heat transfer coefficient.

At block 330, the processing device causes the drying parameter and other related information to be displayed (e.g., via the display device 230).

Referring now to FIG. 4, the method 400 begins at block 410, where the processing device implements a freeze-drying processing according to a process recipe.

At block 420, the processing device monitors mass transfer from a product in the freeze-drying chamber (e.g., the chamber 202) to a condenser (e.g., the condenser 204). For example, the mass transfer corresponds to a flow of water vapor from the product in the chamber to the condenser as accumulated ice (desublimation).

At block 430, the processing device computes the drying parameter at a given point or period in time based on the monitored mass transfer.

At block 440, the processing device periodically adjusts the process recipe to cause the computed drying parameter reach and stabilize at or near the target drying parameter, for example, by cycling through blocks 420-440.

It should be understood that the above described operations are exemplary methods 300 and 400 for operating a freeze-drying system, and that, in alternative embodiments, certain operations depicted in FIGS. 3 and 4 be optional or take a simpler form. Moreover, one or more of the blocks of the methods 300 and/or 400 may be performed concurrently and in a different order than shown, as would be appreciated by one of ordinary skill in the art.

It will be apparent from the foregoing description that aspects of the present disclosure may be embodied, at least in part, in software. That is, the techniques may be carried out in a computer system or other data processing system in response to a processing device, for example, executing sequences of instructions contained in a memory. In various embodiments, hardware circuitry may be used in combination with software instructions to implement the present disclosure. Thus, the techniques are not limited to any specific combination of hardware circuitry and software or to any particular source for the instructions executed by the data processing system. In addition, throughout this description, various functions and operations may be described as being performed by or caused by software code to simplify description. However, those skilled in the art will recognize what is meant by such expressions is that the functions result from execution of the code by processing device.

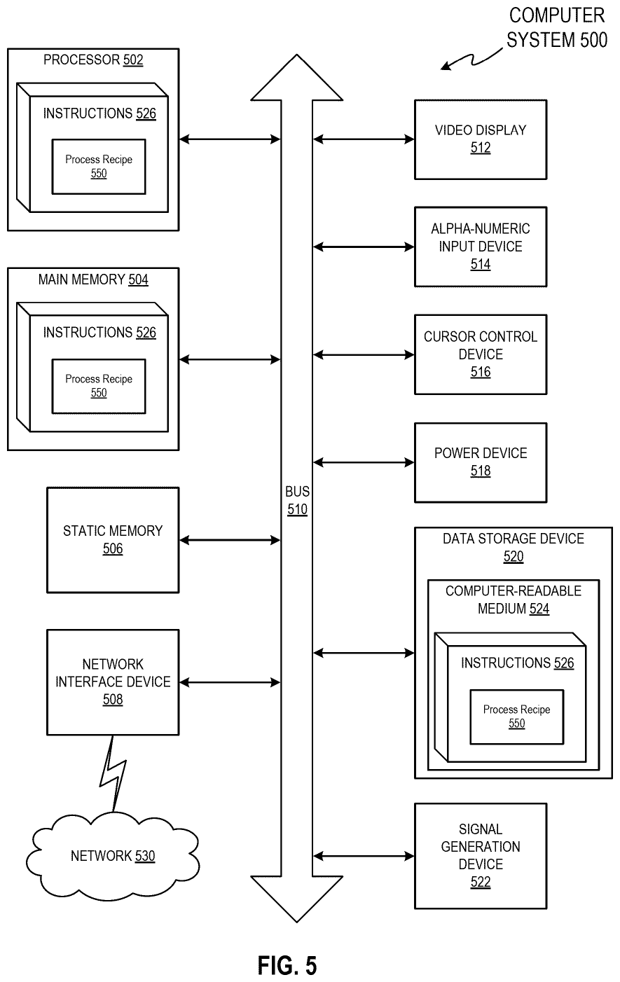

FIG. 5 illustrates a diagrammatic representation of a machine in the exemplary form of a computer system 500 within which a set of instructions (e.g., for causing the machine to perform any one or more of the methodologies discussed herein) may be executed. In alternative embodiments, the machine may be connected (e.g., networked) to other machines in a LAN, an intranet, an extranet, or the Internet. The machine may operate in the capacity of a server or a client machine in client-server network environment, or as a peer machine in a peer-to-peer (or distributed) network environment. The machine may be a personal computer (PC), a tablet PC, a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Some or all of the components of the computer system 500 may be representative of the processing device 220, the display device 230, or various other components or sub-components of the freeze-drying system 200 (such as any of the sensors 208A-208E, the pressure sensor 214, etc.).

The exemplary computer system 500 includes a processing device (processor) 502, a main memory 504 (e.g., read-only memory (ROM), flash memory, dynamic random access memory (DRAM) such as synchronous DRAM (SDRAM) or Rambus DRAM (RDRAM), etc.), a static memory 506 (e.g., flash memory, static random access memory (SRAM), etc.), and a data storage device 520, which communicate with each other via a bus 510.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 502 may also be one or more special-purpose processing devices such as an ASIC, a field programmable gate array (FPGA), a digital signal processor (DSP), network processor, or the like. The processor 502 is configured to execute instructions 526 for performing the operations and steps discussed herein, such as operations associated with execution of a freeze-drying process recipe 550.

The computer system 500 may further include a network interface device 508. The computer system 500 also may include a video display unit 512 (e.g., a liquid crystal display (LCD), a cathode ray tube (CRT), or a touch screen), an alphanumeric input device 514 (e.g., a keyboard), a cursor control device 516 (e.g., a mouse), and/or a signal generation device 522 (e.g., a speaker).

Power device 518 may monitor a power level of a battery used to power the computer system 500 or one or more of its components. The power device 518 may provide one or more interfaces to provide an indication of a power level, a time window remaining prior to shutdown of computer system 500 or one or more of its components, a power consumption rate, an indicator of whether computer system is utilizing an external power source or battery power, and other power related information. In at least one embodiment, indications related to the power device 518 may be accessible remotely (e.g., accessible to a remote back-up management module via a network connection). In at least one embodiment, a battery utilized by the power device 518 may be an uninterruptable power supply (UPS) local to or remote from computer system 500. In such embodiments, the power device 518 may provide information about a power level of the UPS.

The data storage device 520 may include a computer-readable storage medium 524 on which is stored one or more sets of instructions 526 (e.g., software) embodying any one or more of the methodologies or functions described herein. The instructions 526 may also reside, completely or at least partially, within the main memory 504 and/or within the processor 502 during execution thereof by the computer system 500, the main memory 504 and the processor 502 also constituting computer-readable storage media. The instructions 526 may further be transmitted or received over a network 530 (e.g., the network 105) via the network interface device 508.

In one embodiment, the instructions 526 include instructions for implementing the functionality of a freeze-drying system (e.g., such as freeze-drying systems 100 and 200), as described throughout this disclosure. While the computer-readable storage medium 524 is shown in an exemplary embodiment to be a single medium, the terms “computer-readable storage medium” or “machine-readable storage medium” should be taken to include a single medium or multiple media (e.g., a centralized or distributed database, and/or associated caches and servers) that store the one or more sets of instructions. The terms “computer-readable storage medium” or “machine-readable storage medium” shall also be taken to include any transitory or non-transitory medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

The disclosure also relates to an apparatus, device, or system for performing the operations herein. This apparatus, device, or system may be specially constructed for the required purposes, or it may include a general purpose computer selectively activated or reconfigured by a computer program stored in the computer. Such a computer program may be stored in a computer- or machine-readable storage medium, such as, but not limited to, any type of disk including floppy disks, optical disks, compact disk read-only memories (CD-ROMs), and magnetic-optical disks, read-only memories (ROMs), random access memories (RAMs), EPROMs, EEPROMs, magnetic or optical cards, or any type of media suitable for storing electronic instructions.

Some portions of the detailed description may have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is herein, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the preceding discussion, it is appreciated that throughout the description, discussions utilizing terms such as “monitoring,” “adjusting,” “maintaining,” “initiating,” “executing,” “configuring,” “receiving,” “converting,” “causing,” “applying,” “displaying,” “retrieving,” “transmitting,” “providing,” “computing,” “generating,” “adding,” “subtracting,” “multiplying,” “dividing,” “selecting,” “parsing,” “optimizing,” “calibrating,” “detecting,” “storing,” “performing,” “analyzing,” “determining,” “enabling,” “identifying,” “modifying,” “transforming,” “extracting,” “running,” “scheduling,” “processing,” “presenting,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The following exemplary embodiments are now described.

Embodiment 1: A freeze-drying system comprising: a freeze-drying chamber; a condenser coupled to the freeze-drying chamber; one or more load sensors; and a processing device operatively coupled to the one or more load sensors and configured to measure mass change of components of the freeze-drying system during a freeze-drying process.

Embodiment 2: The freeze-drying system of Embodiment 1, wherein at least one of the one or more load sensors are disposed on support structures of the freeze-drying chamber.

Embodiment 3: The freeze-drying system of either Embodiment 1 or Embodiment 2, wherein at least one of the one or more load sensors are disposed on support structures of the condenser.

Embodiment 4: The freeze-drying system of any one of the preceding Embodiments, wherein the freeze-drying chamber further comprises a stoppering mechanism configured to apply pressure to a shelf stack disposed within the freeze-drying chamber, and wherein one or more of the one or more load sensors are disposed on the stoppering mechanism.

Embodiment 5: A freeze-drying system comprising: a freeze-drying chamber; a condenser coupled to the freeze-drying chamber via one or more conduits; a hydraulic ram configured to apply pressure to a shelf stack disposed within the freeze-drying chamber at a pressure plate; a hydraulic fluid pressure sensor configured to measure pressure on the hydraulic ram; and a processing device operatively coupled to the hydraulic fluid pressure sensor to measure mass change on the shelf stack during a freeze-drying process.

Embodiment 6: The freeze-drying system of any one of the preceding Embodiments, wherein the measured mass change corresponds to ice accumulation on the condenser during the freeze-drying process.

Embodiment 7: The freeze-drying system of Embodiment 6, wherein the processing device is further configured to compute a drying parameter of a product in the freeze-drying chamber corresponding to a given point or period in time based on mass transfer from the product to the condenser as accumulated ice during the freeze-drying process.

Embodiment 8: The freeze-drying system of Embodiment 7, wherein the drying parameter is selected from a batch average temperature, cake resistance, and heat transfer coefficient.

Embodiment 9: A method of computing batch average temperature of a product during a freeze-drying process at a given point or period in time, the method comprising: monitoring, by a processing device, mass transfer from the product to a condenser as accumulated ice during the freeze-drying process; and computing, by the processing device, a drying parameter of the product based on the monitored mass transfer.

Embodiment 10: The method of Embodiment 9, wherein the drying parameter is selected from a batch average temperature, cake resistance, and heat transfer coefficient.

Embodiment 11: The method of either Embodiment 9 or Embodiment 10, wherein monitoring the mass transfer comprises monitoring mass change via one or more load sensors disposed on support structures of a freeze-drying chamber containing the product.

Embodiment 12: The method of any one of Embodiments 9-11, wherein monitoring the mass transfer comprises monitoring mass change via one or more load sensors disposed on support structures of the condenser.

Embodiment 13: The method of any one of Embodiments 9-12, wherein monitoring the mass transfer comprises monitoring mass change via one or more load sensors disposed on a hydraulic ram configured to apply pressure to a shelf stack disposed within a freeze-drying chamber containing the product.

Embodiment 14: The method of any one of Embodiments 9-13, wherein monitoring the mass transfer comprises monitoring mass change via a hydraulic fluid pressure sensor configured to measure pressure of a hydraulic ram configured to apply pressure to a shelf stack disposed within a freeze-drying chamber containing the product.

Embodiment 15: The method of any one of Embodiments 9-14, further comprising: causing, by the processing device, a display device to display the drying parameter during the freeze-drying process.

Embodiment 16: A non-transitory machine-readable medium having instructions encoded thereon that, when executed by a processing device of a freeze-drying system, cause the processing device to implement the freeze-drying process of any one of Embodiments 9-15.

Embodiment 17: A method comprising: implementing, by a processing device, a freeze-drying process for a freeze-drying system according to a process recipe, the process recipe specifying a drying parameter for a product; monitoring, by the processing device, mass transfer from the product to a condenser as accumulated; computing, by the processing device, the drying parameter at a given point or period in time based on the monitored mass transfer; and periodically adjusting, by the processing device, the process recipe to cause the computed drying parameter reach and stabilize at or near a target batch average temperature.

Embodiment 18: The method of Embodiment 17, wherein the drying parameter is selected from a batch average temperature, cake resistance, and heat transfer coefficient.

Embodiment 19: The method of either Embodiment 17 or Embodiment 18, wherein monitoring the mass transfer comprises monitoring mass change via one or more load sensors disposed on support structures of a freeze-drying chamber containing the product.

Embodiment 20: The method of any one of Embodiments 17-19, wherein monitoring the mass transfer comprises monitoring mass change via one or more load sensors disposed on support structures of the condenser.

Embodiment 21: The method of any one of Embodiments 17-20, wherein monitoring the mass transfer comprises monitoring mass change via one or more load sensors disposed on a hydraulic ram configured to apply pressure to a shelf stack disposed within a freeze-drying chamber containing the product.

Embodiment 22: The method of any one of Embodiments 17-21, wherein monitoring the mass transfer comprises monitoring mass change via a hydraulic fluid pressure sensor configured to measure pressure of a hydraulic ram configured to apply pressure to a shelf stack disposed within a freeze-drying chamber containing the product.

Embodiment 23: The method of any one of Embodiments 17-22, further comprising: causing, by the processing device, a display device to display the drying parameter during the freeze-drying process.

Embodiment 24: A non-transitory machine-readable medium having instructions encoded thereon that, when executed by a processing device of a freeze-drying system, cause the processing device to implement the freeze-drying process of any one of Embodiments 17-23.

In the foregoing description, numerous details are set forth. It will be apparent, however, to one of ordinary skill in the art having the benefit of this disclosure, that the present disclosure may be practiced without these specific details. In some instances, well-known structures and devices are shown in block diagram form, rather than in detail, in order to avoid obscuring the present disclosure.

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Reference throughout this specification to “certain embodiments,” “one embodiment,” “at least one embodiment,” or the like means that a particular feature, structure, or characteristic described in connection with the embodiment is included in at least one embodiment. Thus, the appearances of the phrase “certain embodiments,” “one embodiment,” “at least one embodiment,” or the like in various places throughout this specification are not necessarily all referring to the same embodiment.

The present disclosure is not to be limited in scope by the specific embodiments described herein. Indeed, other various embodiments of and modifications to the present disclosure, in addition to those described herein, will be apparent to those of ordinary skill in the art from the description and accompanying drawings. Thus, such other embodiments and modifications are intended to fall within the scope of the present disclosure. Further, while the present disclosure has been described in the context of a particular embodiment in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein, along with the full scope of equivalents to which such claims are entitled.

It is to be understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A freeze-drying system comprising:
a freeze-drying chamber;
a condenser coupled to the freeze-drying chamber;
one or more load sensors; and
a processing device operatively coupled to the one or more load sensors and configured to measure mass change of components of the freeze-drying system during a freeze-drying process.

2. The freeze-drying system of claim 1, wherein the one or more load sensors are disposed on support structures of the freeze-drying chamber.

3. The freeze-drying system of claim 1, wherein the one or more load sensors are disposed on support structures of the condenser.

4. The freeze-drying system of claim 1, wherein the freeze-drying chamber further comprises a stoppering mechanism configured to apply pressure to a shelf stack disposed within the freeze-drying chamber, and wherein the one or more load sensors are disposed on the stoppering mechanism.

5. A freeze-drying system comprising:
a freeze-drying chamber;
a condenser coupled to the freeze-drying chamber via one or more conduits;
a hydraulic ram configured to apply pressure to a shelf stack disposed within the freeze-drying chamber at a pressure plate;
a hydraulic fluid pressure sensor configured to measure pressure on the hydraulic ram; and
a processing device operatively coupled to the hydraulic fluid pressure sensor to measure mass change on the shelf stack during a freeze-drying process.

6. The freeze-drying system of claim 1, wherein the measured mass change corresponds to ice accumulation on the condenser during the freeze-drying process.

7. The freeze-drying system of claim 6, wherein the processing device is further configured to compute a drying parameter of a product in the freeze-drying chamber corresponding to a given point or period in time based on mass transfer from the product to the condenser as accumulated ice during the freeze-drying process.

8. The freeze-drying system of claim 7, wherein the drying parameter is selected from a batch average temperature, cake resistance, and heat transfer coefficient.

9. A method of computing batch average temperature of a product during a freeze-drying process at a given point or period in time, the method comprising:
monitoring, by a processing device, mass transfer from the product to a condenser as accumulated ice during the freeze-drying process; and
computing, by the processing device, a drying parameter of the product based on the monitored mass transfer.

10. The method of claim 9, wherein the drying parameter is selected from a batch average temperature, cake resistance, and heat transfer coefficient.

11. The method of claim 9, wherein monitoring the mass transfer comprises monitoring mass change via one or more load sensors disposed on support structures of a freeze-drying chamber containing the product.

12. The method of claim 9, wherein monitoring the mass transfer comprises monitoring mass change via one or more load sensors disposed on support structures of the condenser.

13. The method of claim 9, wherein monitoring the mass transfer comprises monitoring mass change via one or more load sensors disposed on a hydraulic ram configured to apply pressure to a shelf stack disposed within a freeze-drying chamber containing the product.

14. The method of claim 9, wherein monitoring the mass transfer comprises monitoring mass change via a hydraulic fluid pressure sensor configured to measure pressure of a hydraulic ram configured to apply pressure to a shelf stack disposed within a freeze-drying chamber containing the product.

15. The method of claim 9, further comprising:
causing, by the processing device, a display device to display the drying parameter during the freeze-drying process.

16. A non-transitory machine-readable medium having instructions encoded thereon that, when executed by a processing device of a freeze-drying system, cause the processing device to implement the freeze-drying process of claim 9.

17. A method comprising:
implementing, by a processing device, a freeze-drying process for a freeze-drying system according to a process recipe, the process recipe specifying a drying parameter for a product;
monitoring, by the processing device, mass transfer from the product to a condenser as accumulated;
computing, by the processing device, the drying parameter at a given point or period in time based on the monitored mass transfer; and
periodically adjusting, by the processing device, the process recipe to cause the computed drying parameter reach and stabilize at or near a target batch average temperature.

18. The method of claim 17, wherein the drying parameter is selected from a batch average temperature, cake resistance, and heat transfer coefficient.

19. The method of claim 17, wherein monitoring the mass transfer comprises monitoring mass change via one or more load sensors disposed on support structures of a freeze-drying chamber containing the product.

20. The method of claim 17, wherein monitoring the mass transfer comprises monitoring mass change via one or more load sensors disposed on support structures of the condenser.

21. The method of claim 17, wherein monitoring the mass transfer comprises monitoring mass change via one or more load sensors disposed on a hydraulic ram configured to apply pressure to a shelf stack disposed within a freeze-drying chamber containing the product.

22. The method of claim 17, wherein monitoring the mass transfer comprises monitoring mass change via a hydraulic fluid pressure sensor configured to measure pressure of a hydraulic ram configured to apply pressure to a shelf stack disposed within a freeze-drying chamber containing the product.

23. The method of claim 17, further comprising:
causing, by the processing device, a display device to display the drying parameter during the freeze-drying process.

24. A non-transitory machine-readable medium having instructions encoded thereon that, when executed by a processing device of a freeze-drying system, cause the processing device to implement the freeze-drying process of claim 17.
